(19) United States
(12) Patent Application Publication
(10) Pub. No.: US 2023/0099895 A1
(43) Pub. Date: Mar. 30, 2023

(54) METHODS AND APPARATUS FOR FACILITATING ROUTING OF AUTONOMOUS VEHICLES USING DEFINED GEOGRAPHICAL AREAS AND CONSTRAINTS

(71) Applicant: Nuro, Inc., Mountain View, CA (US)

(72) Inventors: Tony Jiang, Campbell, CA (US); Lindsay Yang, Mountain View, CA (US); Kavi Mehta, Mountain View, CA (US)

(21) Appl. No.: 17/875,563

(22) Filed: Jul. 28, 2022

Related U.S. Application Data
(60) Provisional application No. 63/248,133, filed on Sep. 24, 2021.

(51) Int. Cl. B60W 60/00; G01C 21/34

(52) U.S. Cl. CPC B60W 60/001; G01C 21/3446; G01C 21/3476; G01C 21/3461; B60W 2720/10; B60W 2556/45; B60W 2552/10

(57) ABSTRACT

According to one aspect, routing of an autonomous or semi-autonomous vehicle may be based at least in part upon the availability of particular geographical areas through which the vehicle may be routed. A geographical area may be defined, based on constraints such as road conditions, lane features, operational constraints, etc., such that at least one routing path between each of one or more sources and one or more destinations within the geographical area may be traversed by a vehicle. Constraints may be temporary and may be accounted for substantially in real-time when defining and/or updating a geographical area within which a vehicle is to operate. In some instances, an inclusion constraint can be defined based on a frequency of use of a given routing path associated with one or more points of interest for a geographical area. Accounting for constraints enables autonomous vehicles to be deployed safely and efficiently.

### CROSS-REFERENCE TO RELATED APPLICATION

This application claims priority to U.S. Provisional Application No. 63/248,133, filed Sep. 24, 2021, the entirety of which is incorporated herein by reference.

### TECHNICAL FIELD

The disclosure relates to autonomous vehicles. More particularly, the disclosure relates to systems which facilitate the routing of autonomous and other vehicles between a source and a destination.

### BACKGROUND

When paths or routes are planned for vehicles between a start point and an end point, many factors are typically considered. The ability to determine factors that may affect a potential path that may be traversed by vehicles can improve the efficiency with which vehicles such as autonomous vehicles may be deployed.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4A is a diagrammatic representation of a portion of a street map which includes a start point and an end point in accordance with an embodiment.

FIG. 4B is a diagrammatic representation of a portion of the street map of FIG. 4A, which shows a routing area, such as a waffle area, in accordance with an embodiment.

FIG. 4C is a diagrammatic representation of a portion of the street map of FIGS. 4A and 4B, which shows a routing path routed within a routing area, in accordance with an embodiment.

FIG. 5A is diagrammatic representation of a portion of a street map which includes a geographic area which is not available for routing purposes in accordance with an embodiment.

FIG. 5B is a diagrammatic representation of a portion of the street map of FIG. 5A, which shows a routing area, such as a waffle area, defined around an excluded area in accordance with an embodiment.

FIG. 5C is a diagrammatic representation of a portion of the street map of FIG. 5A, which shows a routing area, such as a waffle area, defined to avoid an excluded area in accordance with an embodiment.

FIG. 6A is diagrammatic representation of a portion of a street map which include a point of interest, e.g., a location, which is to be avoided for routing purposes in accordance with an embodiment.

FIG. 6B is a diagrammatic representation of a portion of the street map of FIG. 6A, which shows a routing area, such as a waffle area, defined around a point of interest that is to be excluded from a routing path in accordance with an embodiment.

FIG. 6C is a diagrammatic representation of a portion of the street map of FIG. 6A, which shows a routing area, such as a waffle area, defined to avoid a point of interest that is to be excluded from a routing path in accordance with an embodiment.

FIG. 6D is a diagrammatic representation of a portion of the street map of FIG. 6A, which shows a routing area, such as a waffle area, defined to avoid a particular lane from a routing path in accordance with an embodiment.

FIG. 7A is a block diagram representation of a system configured to use information associated with areas that are to be avoided when determining an area in which an autonomous vehicle may be routed in accordance with an embodiment.

FIG. 7B is a block diagram representation of another system configured to use information associated with areas that are to be avoided when determining an area in which an autonomous vehicle may be routed in accordance with an embodiment.

FIG. 8 is a process flow diagram which illustrates a method of creating defined geographical areas for use in generating routing paths between one or more source locations and one or more destination locations in accordance with an embodiment.

FIG. 9 is a process flow diagram which illustrates a method of providing an updated geographical area for use in generating routing paths between one or more source locations and one or more destination locations when an area, zone, or point of interest of the geographical area is at least temporarily inaccessible in accordance with an embodiment.

FIGS. 10A and 10B are a process flow diagram which illustrates a method of providing an updated geographical area for use in generating routing paths between one or more source locations and one or more destination locations when at least one point of interest of the geographical area is associated with an inclusion constraint that can be used to determine whether the at least one point of interest is or is not suitable for inclusion in at least one of the geographical area or one or more routing paths in accordance with an embodiment.

FIG. 11 is a process flow diagram illustrating another method in accordance with an embodiment.

### DESCRIPTION OF EXAMPLE EMBODIMENTS

### General Overview

In one embodiment, the routing of an autonomous or semi-autonomous vehicle may be based, at least in part, upon the availability of particular geographical areas through which the vehicle may be routed. A geographical area may be defined based on constraints, also referred to herein as routing constraints, such that at least one path between each of one or more source location(s) and one or more destination location(s) within the geographical area may be traversed by a vehicle, such as an autonomous vehicle of an autonomous vehicle fleet. In some instances, constraints may be temporary and such temporary constraints may be accounted for substantially in real-time when defining and/or updating a geographical area within which a vehicle is to operate or be routed between source and destination locations. Accounting for constraints enables autonomous vehicles to be deployed safely and efficiently.

In at least one embodiment, a computer-implemented method is provided that may include determining one or more routing constraints for an autonomous vehicle fleet comprising a plurality of autonomous vehicles, wherein the one or more routing constraints comprise at least one inclusion constraint that is based on satisfying an inclusion threshold associated with a path that has been previously used by the autonomous vehicle fleet in which the inclusion threshold is based on a frequency of use of the path; and defining a geographical area that satisfies the one or more routing constraints, wherein the geographical area is used to generate one or more routing paths that enable at least one autonomous vehicle of the autonomous vehicle fleet to travel between the one or more source locations and the one or more destination locations within the geographical area.

### Description

When a path between two points, e.g., a source point or location and an end point or location, is to be defined such that a vehicle such as an autonomous vehicle may travel between the two points or locations, constraints are generally accounted for in order to substantially ensure that the autonomous vehicle may successfully travel between the two points or locations. The ability to accurately account for constraints, both temporary and substantially permanent, enables paths to be planned in an efficient manner. As such, the efficiency with which overall deployment of a fleet of autonomous and/or semi-autonomous vehicles may be managed and deployed is increased.

By generating a routing path for an autonomous vehicle based on constraints, the ability for the autonomous vehicle to successfully navigate the path may be increased. A geographical area, or a “waffle,” may be defined based on any number of constraints such that substantially every path within the geographical area meets the constraints. The constraints may vary widely and may include, but are not limited to including, specifying one or more geographical zones, points of interest, etc. that are to be excluded from the geographical area/waffle, specifying one or more lanes of a road that are to be excluded from the geographical area/waffle, specifying that no unprotected turns are to be executed for one or more geographical zones, roads, lanes, etc. for the geographical area, specifying that speed limits on one or more roads within and/or surrounding the geographical area are to be below a predetermined value or are to satisfy a threshold value (e.g., less than or equal to, within a particular range or ranges, etc.), combinations thereof, and/or the like.

As will be understood by those skilled in the art, an unprotected turn may be a turn which is not facilitated by a turn signal or a stop sign. For example, in an environment in which vehicles travel on the right-hand side of a road, an unprotected turn may be a left turn with a risk of oncoming traffic in which the vehicle turning left is expected to yield to oncoming traffic.

Other constraints considered when defining a geographical area may include, but are not limited to including, constraints which may be relatively temporary and may effectively be applied to an existing geographical area either to update borders of the geographical area, to effectively redefine the geographical area, and/or to perform any combination of updates to the geographical area. For example, a constraint that may be relatively temporary may be a constraint that specifies that a particular road is currently impassable due to an accident, or may be a constraint that is implemented when a threshold number of times a vehicle belonging to a vehicle fleet, a vehicle of a certain type, a vehicle traveling according to a certain criteria, or the like is allowed to travel on a road, in a particular lane, past a particular address, etc. (broadly, a location or point of interest) during a particular time period is exceeded such that the particular road/lane/address/etc. (location or point of interest) is considered impassable and/or is excluded from routing paths determined within a geographical area for a period and/or periods of time. Such constraints may be referred to herein as “inclusion constraints.”

Generally in accordance with embodiments herein and as discussed in further detail herein below, an “inclusion constraint” may be a type of a routing constraint that can be defined such that one or more points of interest or locations on a map may be identified that are not suitable for inclusion in a routing path and/or as part of a defined geographical area within which routing paths may be defined, such that the point(s) of interest/location(s) are effectively excluded from the routing path(s) and/or the defined geographical area (waffle) within which such routing paths may be defined.

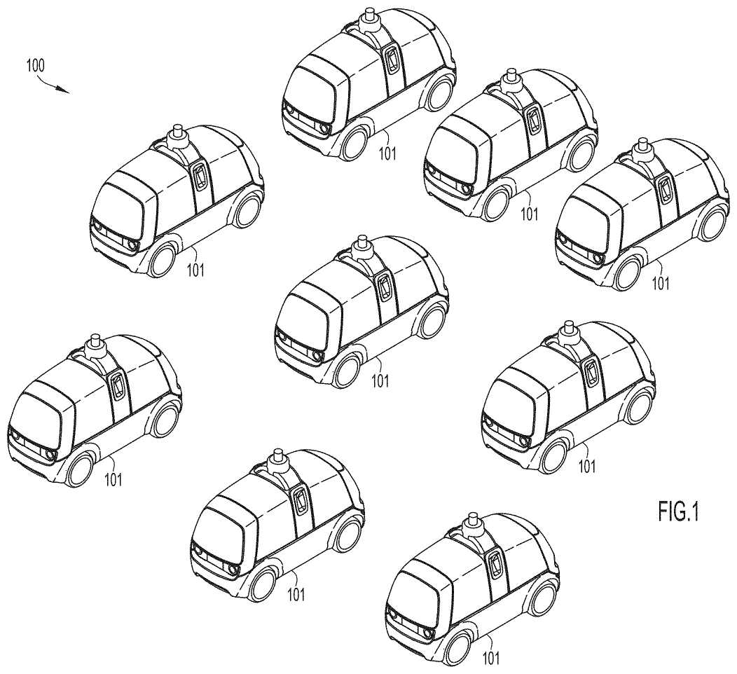

In at least one embodiment, an autonomous or semi-autonomous vehicle which may be routed using defined geographical areas determined based on constraints may be part of a vehicle fleet. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module or system (not shown in FIG. 1). In various embodiments, the fleet management system may dispatch autonomous vehicles 101 for purposes of transporting, delivering, and/or retrieving goods or services in any combination of unstructured open environments and/or closed environments.

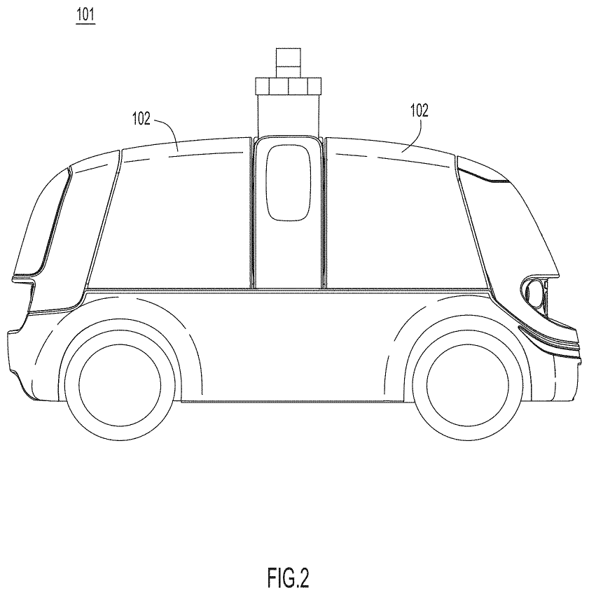

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

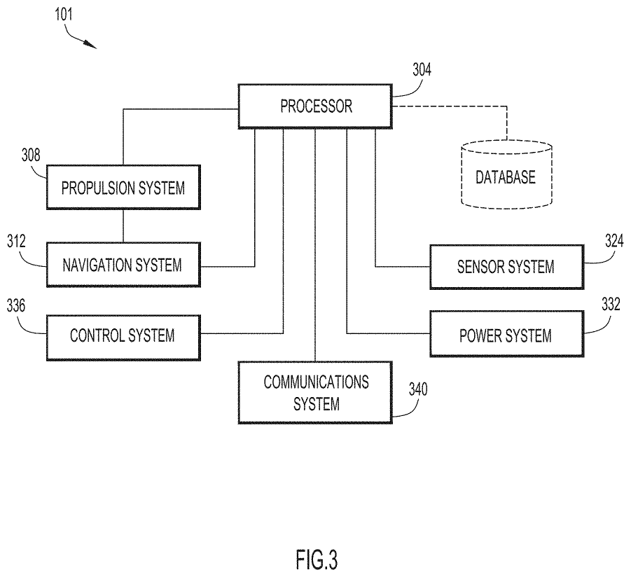

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown in FIG. 3) that allows autonomous vehicle 101 to be controlled remotely. Communications system 340 generally obtains or receives data, stores the data, and transmits or provides the data to a fleet management system and/or to autonomous vehicles 101 within autonomous vehicle fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning system (GPS) server, a personal computer, a teleoperations system, a smartphone, or any computing device via the communications system 340.

In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling the autonomous vehicle 101. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

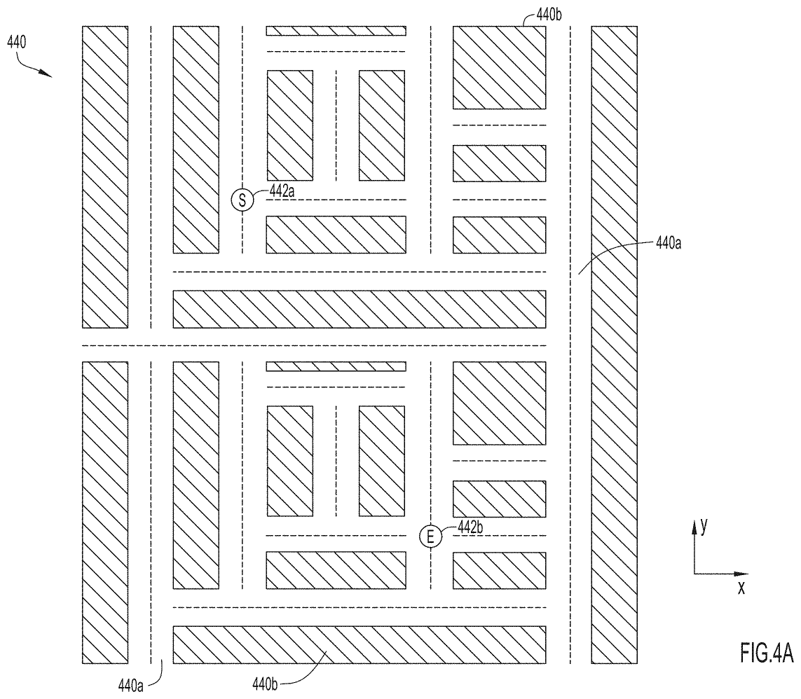

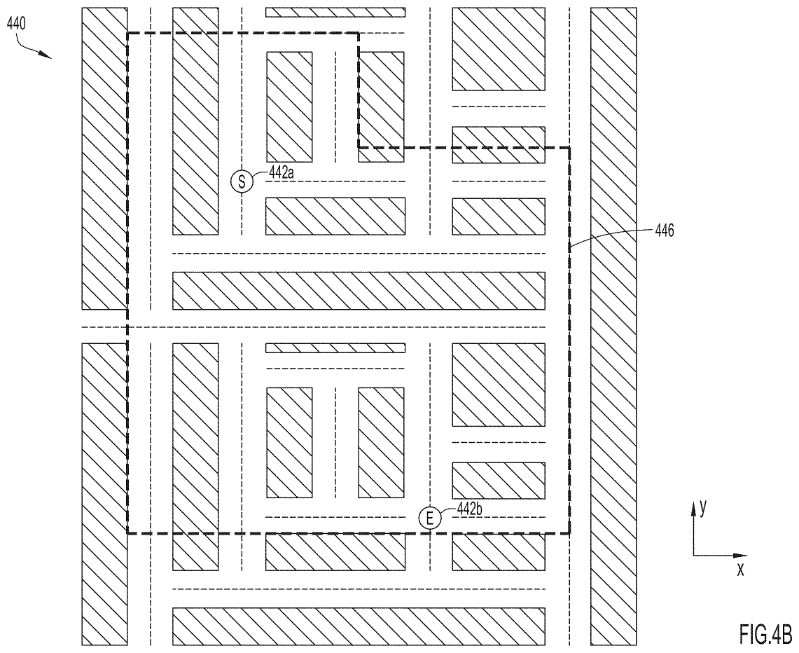

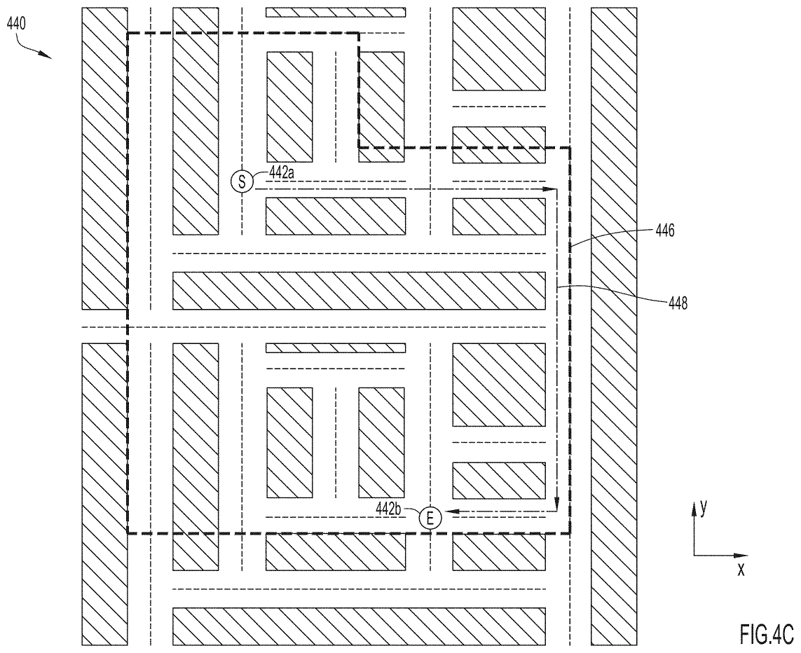

In one embodiment, a system, such as a dynamic routing system, that effectively defines geographical areas within which each point or location within an area may be reached from another point or location within the area may use one or more constraints to define the geographical areas. FIG. 4A is a diagrammatic representation of a portion of a street map which includes a start point and an end point in accordance with an embodiment. A street map 440, or more generally a map, generally includes features such as roads or streets 440a, which may be divided into lanes, and other features 440b. Other features 440b may include, but are not limited to including, buildings, parking lots, bodies of water, natural areas such as landscaped areas and/or other areas which are not roads, road signs (e.g., stop, yield, one-way, speed limit, etc.), and/or traffic signals.

A source location or start point 442a and a destination location or end point 442b are illustrated within street map 440. When a geographical area or a waffle is defined with respect to street map 440, substantially every point or location within the geographical area may be reached while specified constraints are met. FIG. 4B is a diagrammatic representation of a street map 440 which shows a geographical area or a waffle, in accordance with an embodiment. A waffle or geographical area is shown with respect to street map 440. Geographical area 446 is shown as being substantially polygonal in shape, although it should be appreciated that the shape of geographical area 446 is not limited to being polygonal. For example, geographical area 446 may be an area that is bounded or defined by roads, such as all lanes of particular roads or less than all of the lanes of particular road(s), e.g., a single lane of a road may be included in geographical area 446 while other lanes of the road may be substantially excluded from geographical area 446. That is, when geographical area 446 is defined, individual lanes of roads may be considered separately for inclusion within geographical area 446.

In general, constraints used to define geographical area 446 may vary widely. Constraints may include, but are not limited to including, specific lanes or roads which are to be included, specific lanes or roads which are to be excluded, specific areas that are to be excluded, the exclusion of unprotected turns, and/or speed limits (e.g., roads having speed limits in excess of a given threshold). Other constraints, such as communications constraints, may also be considered for defining geographical area 446. For example, communication constraints associated with cellular network signal strength when vehicles may be operated using teleoperations, may also be considered when defining geographical area 446 in which the geographical area 646 may be defined such that cellular network signal strength within the geographical area may be above a certain signal strength threshold or within a certain signal strength threshold range. Cellular network signal strength can be measured by autonomous vehicles 101 of autonomous vehicle fleet 100 and can be communicated to the fleet management system for defining and/or updating various geographical areas or waffles.

In one embodiment, geographical area 446 is defined such that each location within geographical area 446 may be reached from other locations within geographical area 446 using at least one path which meets specified constraints. Start point 442a and end point 442b are both located within the boundaries or borders of geographical area 446, and a path may be routed between start point 442a and end point 442b that meets specified constraints.

In various embodiments, a geographical area or waffle, such as geographical area 446 can be defined using any coordinate system, road/lane information, or any other methodology. For example, in at least one embodiment, map 440 may be organized using an X-Y coordinate system (as shown in FIGS. 4A-4C, as well as other mapping illustrations discussed for embodiments herein) in which the geographical area (e.g., boundaries for the geographical area) can be defined using X-Y coordinates. In other embodiments, latitude/longitude coordinates, Global Positioning System (GPS) coordinates, directional information (e.g., north, south, east, west) road names/cross roads/intersections/etc., lane(s) of road(s) (e.g., northbound, southbound, eastbound, westbound), and/or any other mapping/positional-based coordinates/identifiers/indicators and/or combinations thereof may be used to define a geographical area or waffle (e.g., to define boundaries for the area/waffle).

FIG. 4C is a diagrammatic representation of street map 440 shows a path routed from start point 442a to end point 442b in accordance with an embodiment. For example, as illustrated in FIG. 4C, a routing path 448 can be created in which specified constraints may be met, such that a vehicle, e.g., an autonomous vehicle 101, may use the routing path 448 to travel from start point 442a to end point 442b. It is to be understood that multiple routing paths may be generated for the geographical area 446 that may meet specified constraints.

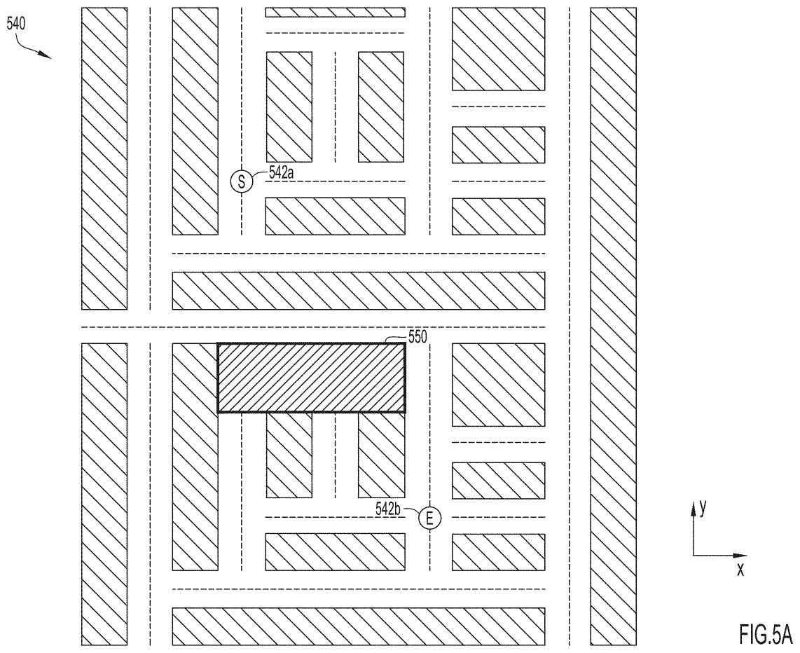

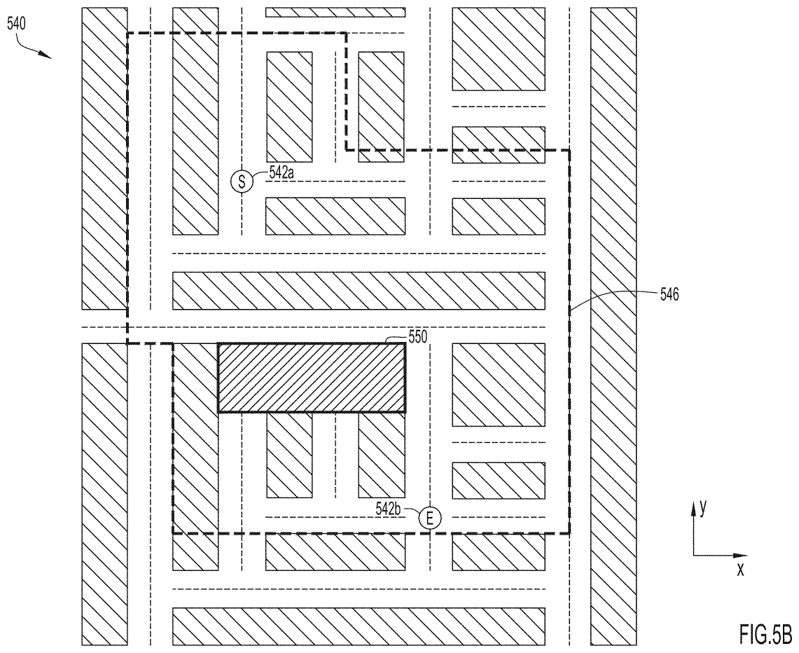

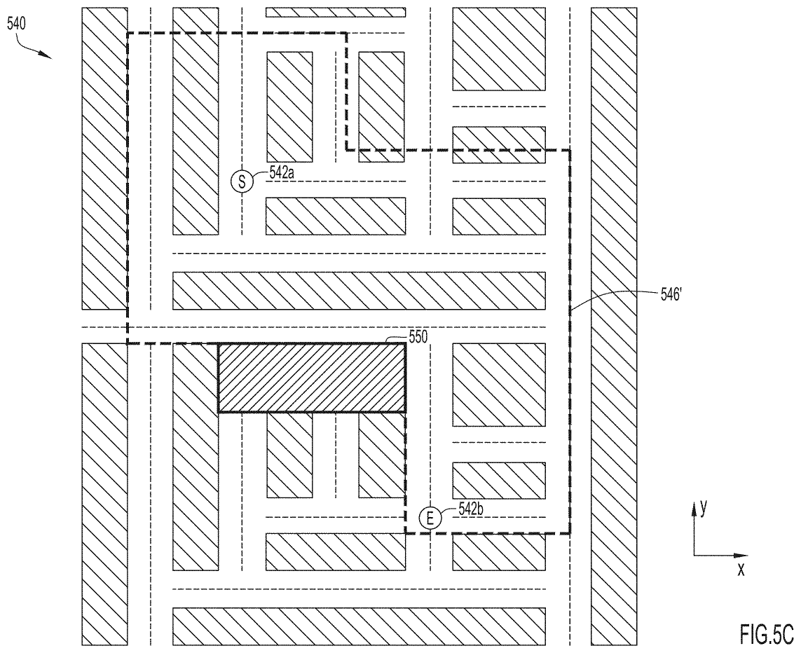

In some instances, there may be zones or areas associated with a map that may become inaccessible either permanently or temporarily. For example, an accident on a road involving multiple vehicles or a natural disaster such as a flood may render at least a portion of the road to be at least temporarily inaccessible. When a portion of a road is inaccessible and, thus, effectively not available to be included in routing paths, identifying the portion of the road as inaccessible facilitates a routing process. FIG. 5A is a diagrammatic representation of a portion of a street map which includes a geographic area which is not available for routing purposes in accordance with an embodiment. A street map 540 includes an inaccessible point of interest or zone 550 that is effectively to be routed around when a path between a start point 542a and an end point 542b is to be routed. In various embodiments, borders associated with inaccessible zone 550 may encompass an obstacle and/or a range around the obstacle.

A geographical area or waffle that is defined to account for specified constraints and inaccessible zone 550 may be such that inaccessible zone 550 is substantially encompassed within the boundaries of the geographical area, or such that inaccessible zone 550 is not substantially encompassed within the boundaries of the geographical area. Referring next to FIG. 5B, a geographical or routing area, e.g., a waffle, defined around inaccessible zone 550 will be discussed in accordance with an embodiment. A geographical area 546 within which a path between start point 542a and end point 542b may be routed includes external boundaries or borders which substantially encompass inaccessible zone 550. Within geographical area 546, inaccessible zone 550 is not available for any paths to be routed therethrough. It should be appreciated that when inaccessible zone 550 is no longer inaccessible, e.g., when an obstacle associated with inaccessible zone 550 is cleared, inaccessible zone 550 may effectively be removed and the external boundaries of geographical area 546 may remain substantially unchanged.

FIG. 5C is a diagrammatic representation of a portion of street map 540 as shown with a routing area that is defined not to encompass inaccessible zone 550 in accordance with an embodiment. A waffle or geographical area 546′ is defined such that inaccessible zone 550 is not encompassed within geographical area 546′. As shown, external boundaries or borders of geographical area 546′ are such that inaccessible zone 550 abuts against or is outside of the external boundaries. It should be understood that when the area covered by inaccessible zone 550 is no longer inaccessible, geographical area 546′ may remain substantially the same or may effectively be redefined.

In some instances, one or more points of interest or locations on a map may be identified as not suitable for inclusion in a routing path and/or as part of a defined geographical area within which routing paths may be defined. Stated differently, an “inclusion constraint” can be defined such that one or more points of interest or locations on a map may be identified that are not suitable for inclusion in a routing path and/or as part of a defined geographical area within which routing paths may be defined. As such, the point(s) of interest/location(s) are effectively excluded from the routing path(s) and/or the defined geographical area (waffle) within which routing paths may be defined for one or more autonomous vehicles 101 of autonomous vehicle fleet 100.

For example, an inclusion constraint may be specified or defined indicating that a particular address is not to be passed by autonomous vehicle(s) 101 of an autonomous vehicle fleet 100 more than a threshold number of times during a predetermined time period. Stated differently, routing paths provided for autonomous vehicle(s) 101 of the autonomous vehicle fleet 100 that include the particular address may only be utilized up to the threshold number. After the threshold number of times during the predetermined time period has been exceeded, autonomous vehicles 101 of the autonomous vehicle may no longer drive or be routed past the particular address until a new time period begins. Such inclusion constraints involving not passing by an address/point of interest or utilizing a path more than a threshold number of times in a period of time may be useful to avoid potential issues (e.g., potential complaints of person(s) at a particular address, potential excess road wear concerns, etc.) involving the potential over-use of a path/paths by an autonomous vehicle fleet.

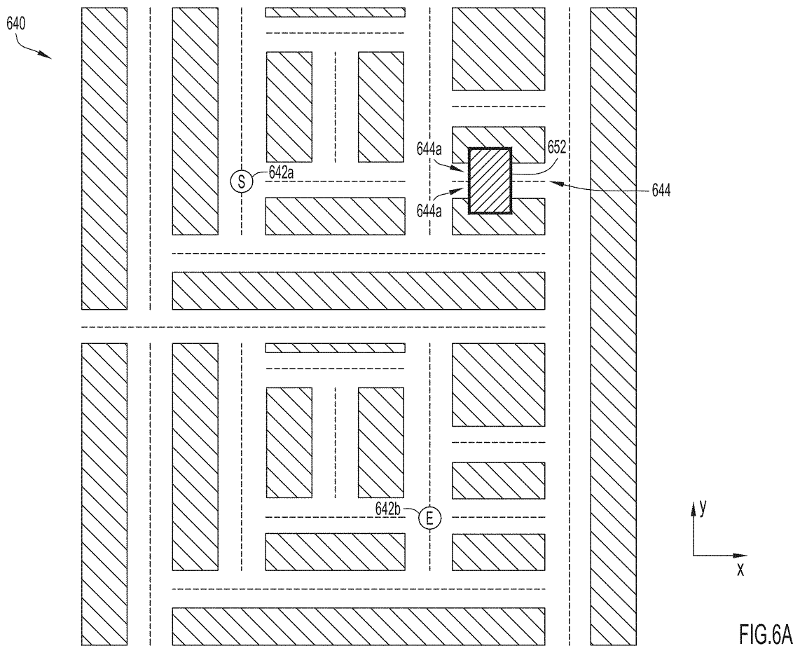

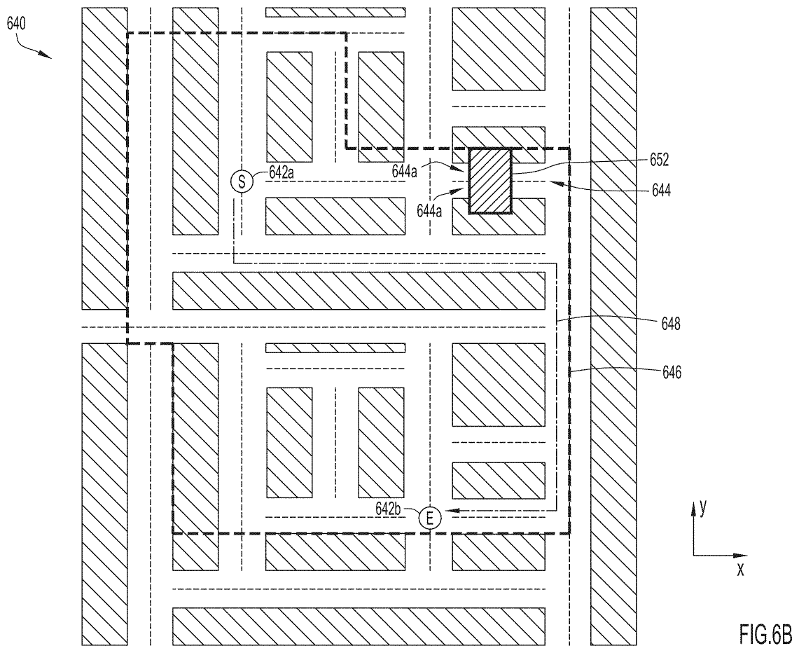

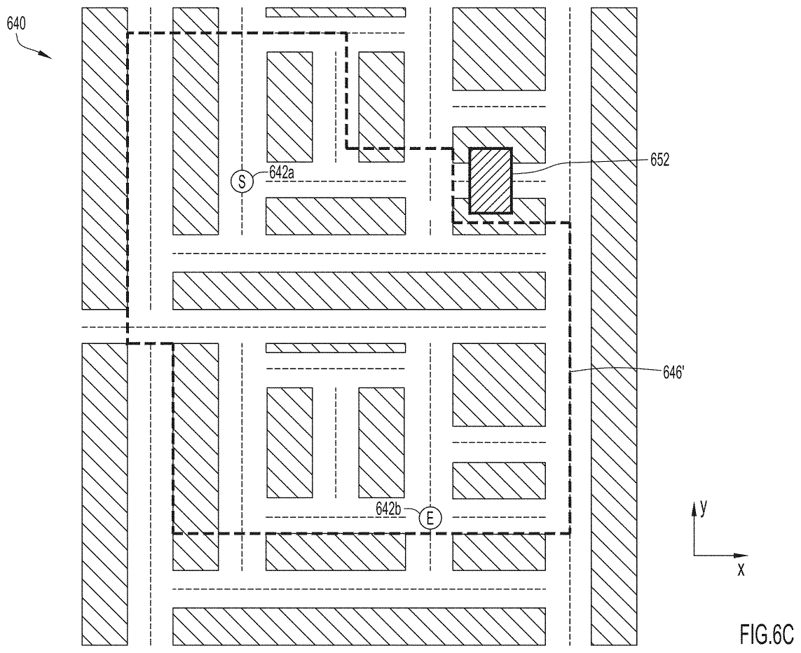

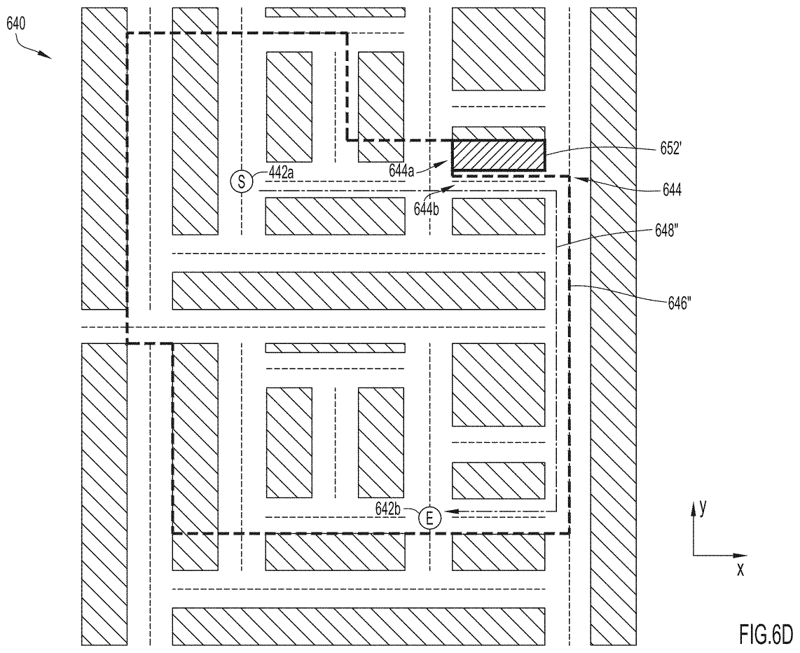

FIG. 6A is diagrammatic representation of a portion of a street map 640 that includes a point of interest 652 (e.g., a location) that is to be avoided for routing purposes in accordance with an embodiment. As shown in FIG. 6A, street map 640 includes point of interest 652 that is to be avoided when defining a geographical area within which a routing path between a source location or start point 642a and a destination location or end point 642b may be defined. As shown in FIG. 6A, a footprint of the point of interest 652 may encompass a first lane 644a and a second lane 644b of a road 644 proximate to the point of interest.

In one instance as shown in FIG. 6B, a geographical area 646 may be defined within street map 640 such that point of interest 652 is substantially encompassed within external boundaries associated with geographical area 646 but can be denoted or otherwise identified as an “inaccessible area” within the geographical area 646. By way of example, geographical area 646 may be defined before point of interest 652 is identified, and a footprint associated with point of interest 652 may effectively be excluded from use in routing paths generated within geographical area 646.

For example, a routing path 648 can be generated by a dynamic routing system in which specified constraints, such as an inclusion constraint in which point of interest 652 is to be excluded from the routing path 648, may be met such that an autonomous vehicle 101 may use the routing path 648 to travel from start point 642a to end point 642b. Thus, an inclusion constraint can be defined that encompasses both lanes of a road (e.g., lanes 644a and 644b of road 644).

Alternatively, as shown in FIG. 6C, a geographical area 646′ may be defined within street map 640 such that point of interest 652 is not encompassed within external boundaries associated with geographical area 646′. That is, geographical area 646′ may be defined to substantially avoid point of interest 652.

In one embodiment, a point of interest that is to be avoided or effectively excluded from a geographical area (not suitable for inclusion within the geographical area) within which a routing path between source location or start point 642a and destination location or end point 642b may be, or may include, a single lane of a road, in contrast to both of first lane 644a and second lane 644b as discussed for the previous example. By way of example, if a building is to be excluded from a geographical area, an inclusion constraint may be defined such that at least one lane of a road on which the building is located may effectively be defined as a point of interest to be excluded. FIG. 6D is a diagrammatic representation of a street map 640 with a geographical area defined to avoid at least one particular lane of a road, such as first lane 644a of road 644, in accordance with an embodiment.

A point of interest 652′ that is effectively excluded from routing consideration in a geographic area 646″ is defined as first lane 644a in road 644. Point of interest 652′ may be, but is not limited to being, a lane of a road on which an address that is not to be along a path between source location or start point 642a and destination location or end point 642b is located. Geographical area 646″ is defined to meet specified constraints or conditions, while exterior boundaries of geographical area 646″ do not encompass point of interest 652′. However, as shown in FIG. 6D, second lane 644b of road 644 may not be included in the inclusion constraint such that the second lane 644b might be included in geographical area 646″. Based on the routing constraints including the inclusion constraint specifying that first lane 644a is not suitable for inclusion in the geographical area 646″, a routing path 648″ can be generated that does include first lane 644a but does include second lane 644b in order to enable an autonomous vehicle 101 to travel between start point 642a and end point 642b.

Accordingly, different levels of granularity may be defined for different points of interest associated with inclusion constraints that may be defined in accordance with embodiments herein. In various embodiments, various points of interest can include two or more lanes of at least one road in which the two or more lanes of the at least one road are associated with two different directions of travel; one lane of at least one road associated with one direction of travel; or one or more geographical addresses or positions located along one or more lanes of at least one road.

Further, as discussed in further detail herein below, an inclusion constraint can be associated with satisfying an inclusion threshold that is based on a frequency of use of a given routing path associated with one or more points of interest in which the inclusion threshold is a value indicating the frequency of use of the path by one or more autonomous vehicles of an autonomous vehicle fleet within a predetermined period of time. Satisfying the inclusion threshold indicates that one or more points of interest are not suitable for inclusion in a geographical area or are not suitable for inclusion in one or more routing paths that enable the at least one autonomous vehicle to travel between one or more source locations and the one or more destination locations within the geographical area.

Consider an example with reference to FIGS. 6A-6D regarding point of interest 652 in which an inclusion constraint can be defined for the point of interest 652 such that the point of interest 652 can be monitored with reference to a threshold number of times that routing paths are generated for autonomous vehicles 101 of autonomous vehicle fleet 100 that may pass by the point of interest 652 within a predetermined amount of time, say, for example, within a 12-hour time period. In one example, consider that the threshold number of times is five (5) times that autonomous vehicles 101 of the autonomous vehicle fleet 100 may pass by the point of interest 652 (using one or both lanes of road 644, depending on the granularity/definition of the inclusion constraint).

In this example, the inclusion threshold could be represented with a frequency of 5 times (passing by the point of interest or, stated differently, the number of times that the point of interest is included in routing paths generated for autonomous fleet 100) within a time period of 12 hours or stated differently, 5 times within a period of 12 hours that routing paths can be generated for the autonomous vehicle fleet 100 that include or pass-by the point of interest 652 (depending on the granularity/definition of the inclusion constraint). In this example, once at least 5 routing paths have been generated within the 12-hour time period that include or pass by the point of interest 652, one or both of a geographical area that includes the point of interest (as shown in FIG. 6B) or excludes the point of interest (as shown in FIG. 6C) can be updated such that routing paths generated for the geographical area can be generated that do not pass by the point of interest, as shown, for example, via routing path 648 of FIG. 6B or routing path 648″ of FIG. 6D.

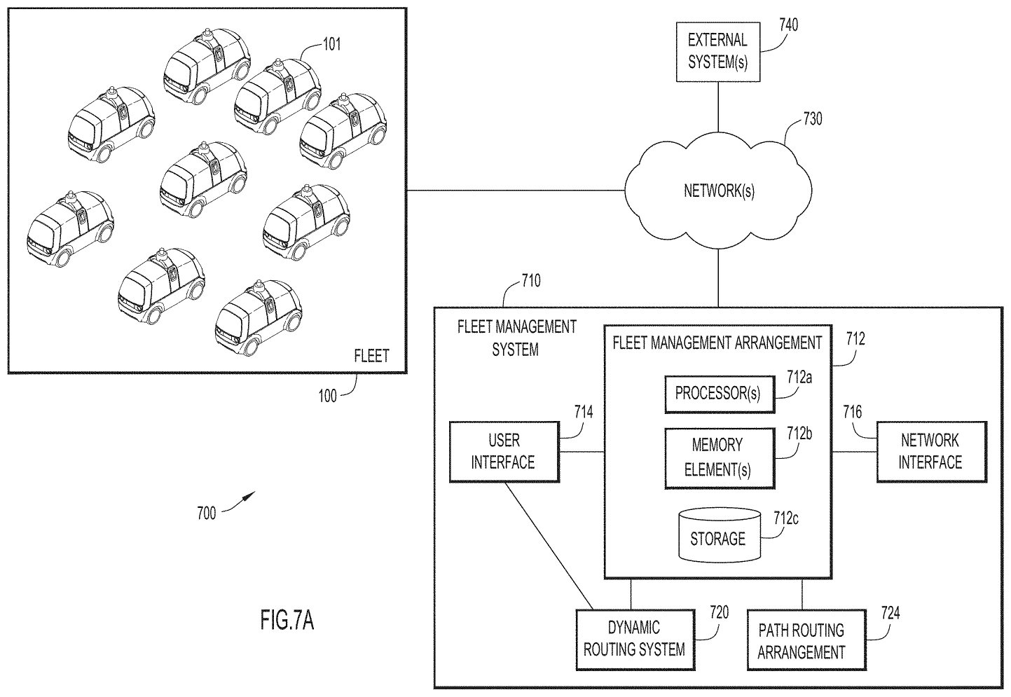

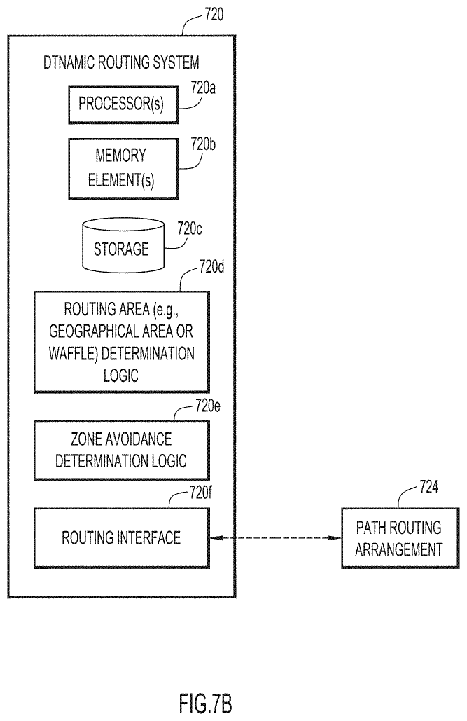

FIG. 7A is an example block diagram representation of a system 700 configured to use information associated with areas that are to be avoided when determining an area in which an autonomous vehicle of an autonomous vehicle fleet may be routed in accordance with an embodiment. As shown, the system 700 may include autonomous vehicle fleet 100 that includes a plurality of autonomous vehicles 101, or robot vehicles. The autonomous vehicles 101 in the autonomous vehicle fleet 100 can be interconnected with a fleet management system 710 via one or more network(s) 730. The network(s) 730 facilitate communications between autonomous vehicle fleet 100 and fleet management system 710 via any communications medium that may be utilized to transmit/receive (wired and/or wirelessly) information between two or more computing devices. For example, network(s) 730 can include any combination of wireless wide area (WWA) access networks, such as any combination of cellular/Third (3rd) Generation Partnership Project (3GPP) access networks (e.g., Fourth (4th) Generation (4G)/Long Term Evolution (LTE) access networks, Fifth (5th) Generation (5G) access networks, next Generation (nG or NG) access networks, etc.) and/or wireless local area (WLA) access networks, such as Institute of Electrical and Electronics Engineers (IEEE) 802.11 (e.g., Wi-Fi®) access networks, and/or any other wireless and/or mobile communication system now known or hereinafter developed that may facilitate communications between two or more computing devices.

Fleet management system 710 can include fleet management arrangement 712, a user interface 714, a network interface 716, a dynamic routing system 720, and a path routing arrangement 724. Generally, fleet management arrangement 712 may include any combination of one or more processor(s) 712a, one or more memory element(s) 712b, and storage 712c. During operation, fleet management arrangement 712 is configured to coordinate operations of the system 700 such that routing instructions can be sent to one or more autonomous vehicles 101 of autonomous vehicle fleet 100 in order to dispatch autonomous vehicles 101 for purposes of transporting, delivering, and/or retrieving goods or services in any combination of unstructured open environments and/or closed environments.

In at least one embodiment, processor(s) 712a is/are at least one hardware processor configured to execute various tasks, operations and/or functions for fleet management system 710 as described herein according to software and/or instructions configured for fleet management system 710. Processor(s) 712a (e.g., hardware processor(s)) can execute any type of instructions associated with data to achieve the operations detailed herein. In one example, processor(s) 712a can transform an element or an article (e.g., data, information) from one state or thing to another state or thing. Any of potential processing elements, graphical processing units (GPUs), microprocessors, digital signal processor, baseband signal processor, modem, physical layer (PHY), computing devices, systems, managers, logic, and/or machines described herein can be construed as being encompassed within the broad term ‘processor’.

In at least one embodiment, memory element(s) 712b and/or storage 712c is/are configured to store or encode data, information, software, logic, and/or instructions associated with fleet management system 710. For example, any logic described herein can, in various embodiments, be stored for fleet management system 710 using any combination of memory element(s) 712b and/or storage 712c. Note that in some embodiments, storage 712c can be consolidated with memory element(s) 712b (or vice versa) or can overlap/exist in any other suitable manner.

In various embodiments, memory element(s) 712b and/or storage 712c may be any suitable storage medium, such as a non-transitory computer-readable storage medium, any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element.’ Data/information being tracked and/or sent to one or more entities as discussed herein could be provided in any database, table, and register, list, cache, storage, and/or storage structure: all of which can be referenced at any suitable timeframe. Any such storage options may also be included within the broad term ‘memory element’ as used herein.

In various embodiments, the user interface 714 is configured to enable interactions between the fleet management system 710 and one or more autonomous vehicles 101 of autonomous vehicle fleet. For example, in some instances, user interface 714 can provide a graphical user interface (GUI) through which an enterprise, fleet operator, or the like may define one or more constraints (e.g., routing constraints) to be utilized by dynamic routing system 720 to facilitate generating or otherwise routing a path between at least one source location and at least one destination location for at least one autonomous vehicle 101 of autonomous vehicle fleet, such that the path is within a particular geographical or routing zone (e.g., a waffle area) that is substantially defined based on the constraints in which each point of interest (e.g., address) within the geographical/routing zone is substantially reachable.

In some embodiments, constraints that that may be utilized by dynamic routing system 720 to facilitate generating or otherwise routing a path between at least one source location and at least one destination location for at least one autonomous vehicle 101 of autonomous vehicle fleet may be obtained (e.g., pushed, pulled, queried, retrieved, etc.) by fleet management system 710 from one or more external system(s) 740. In various embodiments, such external system(s) 740 may include, but not be limited to, real-time traffic databases/services, weather databases/services, crowdsourced databases/services, combinations thereof, and/or the like from which one or more constraints may be determined for generating or otherwise routing a path between a source location and at least one destination location (e.g., road hazards, traffic accidents, road closures, etc.).

In various embodiments, network interface 716 may enable communication between fleet management system 710 and other systems, devices, or entities, via wired and/or wireless network input/output (I/O) interface(s) to facilitate operations, the acquisition of, and/or the distribution of, information, etc. by fleet management system 710 discussed for various embodiments described herein. In various embodiments, network interface 716 can be configured as a combination of hardware and/or software, such as one or more Ethernet driver(s)/port(s) and/or computing device(s) or interface cards, optical driver(s)/port(s) and/or computing device(s) or interface cards, wireless receivers/ transmitters/transceivers, baseband processor(s)/modem(s), antenna(s)/antenna array(s), and/or other similar network interface driver(s)/port(s)/array(s) and/or computing device(s) now known or hereafter developed to enable communications between fleet management system 710 and other systems, devices, or entities to facilitate operations for various embodiments described herein. Thus, the network interface 716 may include suitable interfaces for receiving, transmitting, and/or otherwise communicating data and/or information (wired and/or wirelessly) in a network environment.

As illustrated in FIG. 7A, dynamic routing system 720 and path routing arrangement 724 may be generally located/configured for fleet management system 710, which may be associated with an enterprise or other entity managing autonomous vehicle fleet 100. It should be appreciated, however that dynamic routing system 720 and path routing arrangement 724 may be a distributed system located on multiple hosts.

Consider various additional example details regarding dynamic routing system 720 and path routing arrangement 724 as discussed in further detail with reference to FIG. 7B, which is an example block diagram representation of the dynamic routing system 720, which can be configured to use information associated with areas, e.g., zones or points of interest, that are to be avoided when determining an area in which an autonomous vehicle may be routed in accordance with an embodiment. In at least one embodiment, dynamic routing system 720 is configured to facilitate generating or otherwise routing a path between a source and a destination for an autonomous vehicle such that the path is within a particular geographical or routing zone, e.g., a waffle area, that is substantially defined such that each point of interest, e.g., address, within the routing zone is substantially reachable by the autonomous vehicle.

Dynamic routing system 720 may include one or more processor(s) 720a, one or more memory element(s) 720b, storage 720c, routing area determination logic 720d, zone avoidance determination logic 720e, and a routing interface 720f. Dynamic routing system 720 may include hardware and/or software logic, such as routing area determination logic 720d and zone avoidance determination logic 720e, configured to support the generation or identification of a suitable route or path along which an autonomous vehicle such as autonomous vehicle 101 of FIGS. 2 and 3 may be routed.

Processor(s) 720a are configured to execute software logic or code devices of dynamic routing system 720. In at least one embodiment, memory element(s) 720b and/or storage 720c is/are configured to store data, information, software, logic, and/or encoded instructions associated with dynamic routing system 720. For example, any logic described herein can, in various embodiments, be stored for dynamic routing system 720 using any combination of memory element(s) 720b and/or storage 720c. Note that in some embodiments, storage 720c can be consolidated with memory element(s) 720b (or vice versa) or can overlap/exist in any other suitable manner.

In various embodiments, memory element(s) 720b and/or storage 720c may be any data store, database, etc. that may be arranged to store statistics or other information associated with routing areas and/or zones to be avoided when creating a routing path for an autonomous vehicle. Memory element(s) 720b and/or storage 720c may also store information associated with thresholds. The thresholds may include inclusion thresholds, such as but not limited to, a number of times a particular street, lanes of a street, etc. associated with one or more points of may be traversed within a specified amount of time, a number of times one or more points of interest may effectively be included in a routing path for a route from a source to a destination, combinations thereof, and/or the like.

Routing area determination logic 720d is arranged to define or to otherwise generate a geographical area or waffle within which one or more routing paths between a source and a destination may be created. Routing area determination logic 720d is configured to process information obtained by dynamic routing system 720 through user interface 714, network interface 716, memory element(s) 720b, and/or storage 720c. The information processed may include, but is not limited to including, various routing constraints, such as constraints associated with road requirements such as speed limits and/or lane usage, constraints associated with unprotected turns, and/or other constraints, substantially permanent constraints, temporary constraints, inclusion constraints, combinations thereof, and/or the any other constraints as discussed for various examples described and/or envisioned herein.

Zone avoidance determination logic 720e may process results obtained from routing area determination logic 720d to ascertain whether a geographic zone or other zone is to be avoided when routing a vehicle. In one embodiment, routing area determination logic 720d cooperates with zone avoidance determination logic 720e to create a routing area that avoids particular zones. The zones that are avoided may be substantially permanently avoided, or the zones may be temporarily avoided, e.g., when a temporary obstacle is in place or when a threshold for a number of times a particular point of interest may be passed or traversed is met. Zones may be avoided, but are not limited to being avoided, when the zones are associated with obstructions, the zones are associated with points of interest which have a threshold for a number of routes which may include point(s) of interest (e.g., addresses, lane(s) of a road, etc.) within a particular time frame, and/or zones which are associated with areas of poor cellular network coverage. In one embodiment, zone avoidance determination logic 720e may identify boundaries associated with a geographical area or zone which are to be avoided when a routing path is being created for an autonomous vehicle, such as for an autonomous vehicle 101 of autonomous vehicle fleet 100.

Routing interface 720f is generally configured to provide outputs from routing area determination logic 720d and/or zone avoidance determination logic 720e to a path routing arrangement 724, which may be representative of any mapping system that may interface with fleet management arrangement 712 and/or network interface 716 to enable a routing path for an autonomous vehicle to be determined that considers routing areas while avoiding geographical zone(s) and/or point(s) of interest that are identified as being unsuitable and/or unavailable for routing. In one embodiment, routing interface 720f may be configured to calculate a routing path for an autonomous vehicle. That is, routing interface 720f may include functionality associated with path routing arrangement 724.

Dynamic routing system 720 and path routing arrangement 724 may include any mapping functionality that may be configured to render a map with an overlay arranged to substantially identify an area to be avoided when generating a route or routing path between a source location and at least one destination location. Such a map may provide a visual representation of an area that is to be avoided. That is, dynamic routing system 720 and path routing arrangement 724 may provide visual renderings of routing areas and zones to avoid as overlays on maps rendered on a display screen (not shown).

Accordingly, dynamic routing system 720 and path routing arrangement 724 may generate routing paths for autonomous vehicles 101 of autonomous vehicle fleet 100 such that fleet management system 710 can communicate the routing paths to the autonomous vehicle fleet 100.

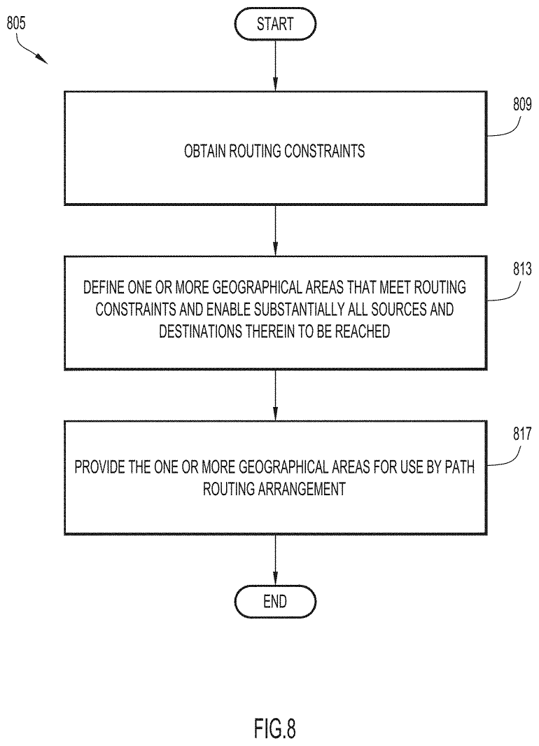

FIG. 8 is a process flow diagram which illustrates a method 805 of creating defined geographical areas, e.g., waffles, for use in generating routing paths between one or more source locations and one or more destination locations in accordance with an embodiment. In at least one embodiment, method 805 may be performed via a dynamic routing system, such as dynamic routing system 720.

The method 805 of creating at least one geographical area within which routing paths may be generated using a path routing arrangement begins at a step 809 in which routing constraints are obtained Routing constraints may be obtained from any suitable source, as for example using a communications arrangement such as a network interface (e.g., network interface 716) and/or a user interface (e.g., interface 714). Suitable sources include, but are not limited to including, databases, any external systems/sources, such as sources which provide reports of road conditions, sources which provide reports of weather conditions, etc. a routing system, and/or administrators associated with a fleet management enterprise.

In various embodiments, routing constraints can include temporary or substantially permanent constraints, inclusion constraints, one or more speed constraints; one or more road hazard or road closure constraints; one or more operational constraints associated with an autonomous vehicle fleet; or one or more communication constraints associated with wireless communication signal strength for communications involving the autonomous vehicle fleet. In various embodiments, operational constraints associated with an autonomous vehicle fleet can include range constraints (e.g., battery level) or other limits on distances to travel, navigational constraints (e.g., no unprotected turns to be taken, number of turns allowed, allowable lanes of travel (such, as rightmost, leftmost, middle, or the like), lane features (designated turning lanes, designated High Occupancy Vehicle (HOV)/carpool lanes, designated bicycle lanes, crosswalks, toll lanes or roads, or the like), etc.), combinations thereof, and/or the like.

In a step 813, one or more geographical areas that meet routing constraints and enable substantially all sources and destinations associated with the geographical areas to be met. That is, the constrains obtained in step 809 are used to define one or more geographical areas. Once the geographical areas are defined, the geographical areas may be provided to a path routing arrangement in a step 817, such as path routing arrangement 724. The path routing arrangement may use the geographical areas to generate one or more routing path between the one or more source locations and the one or more destination locations. As will be appreciated by those skilled in the art, any suitable routing techniques may be applied to route paths within a geographical area. After the geographical areas are provided to the routing system, the method of creating at least one geographical area within which paths may be routed using a path routing arrangement is completed.

In some instances, a portion of a geographical area may eventually be identified as inaccessible, and/or not to be used as part of any path associated with the geographical area. For example, an obstacle or an obstruction may be identified within the footprint covered by the geographical area. In response to the presence of a substantially new obstacle in a geographical area and/or the removal of an older obstacle from the geographical area, the geographical area may be updated.

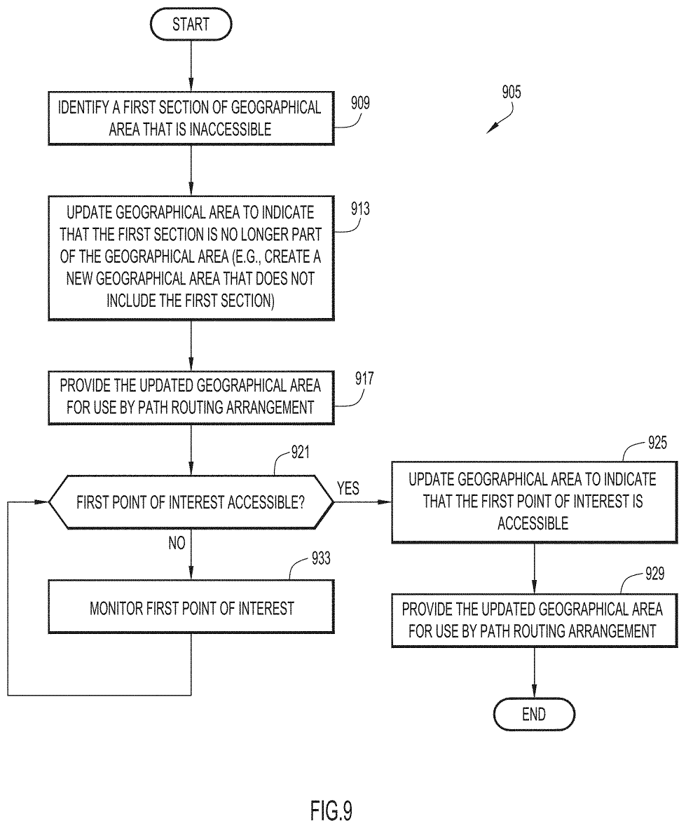

Referring to FIG. 9, FIG. 9 is a process flow diagram which illustrates a method 905 of providing an updated geographical area for use in routing paths between a source and a destination when an area, zone, or point of interest of the geographical area is at least temporarily inaccessible in accordance with an embodiment. In at least one embodiment, method 905 may be performed by a dynamic routing system, such as dynamic routing system 720.

The method 905 of defining and providing an updated geographical area to a path routing arrangement may begin at a step 909 in which a first section or point of interest of a geographical area, i.e., a previously defined geographical area, is identified as being inaccessible. The first point of interest may be specified as being inaccessible based on information obtained from any suitable source, e.g., from observations of road users and/or from updated information provided by a data store that is in communication with a dynamic routing system such external system(s) 740 of FIG. 7A that may be in communication with dynamic routing system 720 of FIGS. 7A and 7B. In one embodiment, the first point of interest may be considered temporarily inaccessible.

Once a first point of interest of a geographical area is identified as being inaccessible, the geographical area may be updated in a step 913 to indicate that the first point of interest is no longer part of the geographical area and, as such, that no paths may pass through the first point of interest. In at least one embodiment, updating the geographical area may include creating a new geographical area that does not include the first section (e.g., as illustrated in FIG. 6C in which point of interest 652 is removed from geographical area 646′). In lieu of creating a new geographical area, the existing geographical area may instead be updated by substantially indicating that the first point of interest is effectively an inaccessible area within the geographical area (e.g., as discussed for FIG. 6B in which point of interest 652 can be identified as an inaccessible area within geographical area 646).

Once the geographical area is updated the updated geographical area may be provided for use by a path routing arrangement in a step 917. That is, the updated geographical area that accounts for the inaccessibility of the first point of interest is provided to a path routing arrangement (e.g., path routing arrangement 724).

From step 917, process flow proceeds to a step 921 in which it is determined whether the first point of interest has become accessible (via monitoring in a step 933). In other words, a determination is made as to whether the first section remains inaccessible. If it is determined that the first section is now accessible, then in a step 925, the geographical area is updated to indicate that the first point of interest is once again accessible. Such an update may include, but is not limited to including, effectively creating a new geographical area that includes the first point of interest as a routable area or indicating that the first point of interest is now accessible within the current geographical area. The updated geographical area is provided for use by a path routing arrangement in a step 929, and the method of defining and providing an updated geographical area to a path routing arrangement is completed.

Returning to step 921, if it is determined that first point of interest is still not accessible, the first point of interest may effectively be monitored in a step 933. Monitoring the first point of interest may include, but is not limited to including, determining whether updated information indicates that the first point of interest is remains inaccessible. Such monitoring may be performed periodically or may effectively be accomplished when information is provided relating to the first point of interest. From step 933, process flow returns to a step 921 in which it is determine whether the first point of interest is accessible.

As mentioned above, some points of interest within an existing geographical area may be temporarily identified or classified as being unavailable for including in a routing path. By way of example, a particular lane of a road may be specified as unavailable once the lane has been included in a threshold number of routing paths generated for autonomous vehicle(s) 101 of autonomous vehicle fleet 100 within a predetermined amount of time. The lane may be associated with a use threshold (also referred to herein as the “inclusion threshold”) in order to avoid overuse of the lane, e.g., at the request of an interested party. That is, lane usage may be the subject of lane frequency optimized routing (LFOR) such that one or more lanes may be optimally included or excluded from one or more routing paths generated for autonomous vehicle fleet in order to limit or avoid overuse of one or more lanes that may be associated with one or more points of interest for geographical area(s) involving one or more source locations and one or more destination locations among which autonomous vehicles 101 of autonomous vehicle fleet 100 may be routed.

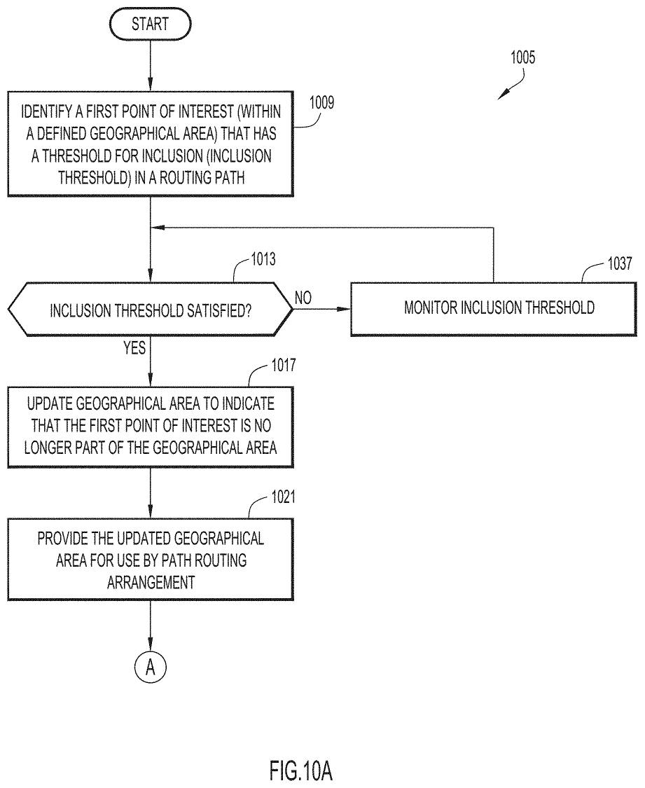

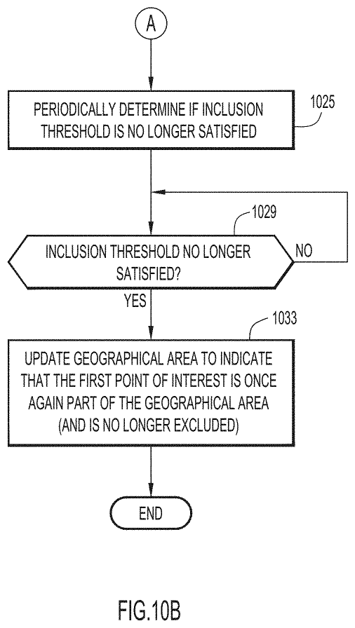

FIGS. 10A and 10B are a process flow diagram which illustrates a method 1005 of providing an updated geographical area for use in routing paths between a source and a destination when a point of interest of the geographical area has an associated threshold for inclusion in a routing path, e.g., when a lane of a road has a threshold for frequency of use (e.g., an inclusion threshold), in accordance with an embodiment. In at least one embodiment, method 1005 may be performed by a dynamic routing system, such as dynamic routing system 720.

The method 1005 of providing an updated geographical area that includes a point of interest that has an associated threshold for inclusion in a path may begin at a step 1009 in which a first point of interest, within a previously defined geographical area, is identified as having a threshold for inclusion as a part of a routing path. The threshold may be an inclusion threshold that is associated with a frequency of use. For example, the inclusion threshold may specify a number of times the first point of interest may be included in a routing path within a particular time frame.

A determination is made in a step 1013 as to whether the inclusion threshold has been satisfied. That is, the determination at 1013 determines whether the first point of interest has been included in a number of (previously) generated routing paths that either meets (i.e., is equal to) or exceeds (i.e., is greater than) the inclusion threshold value within a predetermined period of time/time frame (e.g., 5 times within 12 hours or the like).

Thus, if the determination at step 1013 is that the threshold has been satisfied, the implication is that that the number of times that the point of interest has been included in a number of routing paths within a particular time frame has surpassed the threshold, and that the first point of interest is to be denoted as inaccessible at least until a new period of time/time frame may be set or, stated differently, the current period of time/time frame in which the point of interest is not to be included in routing paths may expire/be reset.

Accordingly, process flow moves to a step 1017 in which the geographical area is updated to indicate that the first point of interest is no longer part of the geographical area. In one embodiment, a new geographical area may essentially be created that does not include the first point of interest in order to indicate that the first point of interest is not suitable for inclusion in one or more routing paths to be generated for the autonomous vehicle fleet 100. However, in another embodiment, the geographical area may be updated to denote or otherwise identify that the first point of interest within the geographical area is inaccessible or otherwise note suitable for inclusion in one or more routing paths to be generated for the autonomous vehicle fleet 100.

In a step 1021, the updated geographical area is provided for use by a path routing arrangement. Then, in a step 1025 and 1029 as illustrated in FIG. 10B, determinations, as for example periodic determinations, are made to determine whether the inclusion threshold is no longer satisfied. That is, the method can include determining that at least one inclusion threshold that was previously satisfied is no longer satisfied. Stated differently, it can be determined whether a reset condition may be satisfied such that the first point of interest may once again be included as part of a geographical area by way of the period of time/time frame associated with the inclusion threshold expiring/being reset/etc.

If the determination at 1029 is that the inclusion threshold is no longer satisfied (YES at 1029), for example, a reset condition has been satisfied such that the period of time/time frame has been satisfied/has expired/has been reset/etc. (e.g., 12 hours has elapsed, etc.), then in a step 1033, the geographical area is updated to indicate that the first point of interest is once again part of the geographical area, and available for paths to be routed to include the first point of interest. In essence, when the inclusion threshold is no longer satisfied, the inclusion constraint can be removed from routing constraints for determining a geographical area/routing paths within the geographical area.

Thus, updating the geographical area can be used to trigger or otherwise initiate updating at least one routing path of the one or more routing paths that enable the at least one autonomous vehicle to travel between one or more source locations and one or more destination locations. After the geographical area is updated, the method of providing an updated geographical area that includes a point of interest which has an associated threshold is completed.

Alternatively, if it is determined in step 1029 that the inclusion threshold is still satisfied (NO at 1029), for example, a reset condition has not been satisfied such that the period of time/time frame has not yet been satisfied or met/has not expired/ has not been reset/etc., then the indication is that the first point of interest is still inaccessible and not suitable for inclusion in one or more routing paths to be generated for the autonomous vehicle fleet 100. As such, process flow returns to step 1025/1029 in which it is periodically determine whether the inclusion threshold is no longer satisfied.

Returning to step 1013, if the determination is that the inclusion threshold has not been satisfied, then the first point of interest may continue to be used in routing paths generated for the geographical area. As such, in a step 1037 in which the threshold is effectively monitored to determine whether the threshold has been satisfied. Such monitoring may occur periodically. Once the threshold is monitored, process flow returns to step 1013 in which a determination is made as to whether the threshold has been satisfied.

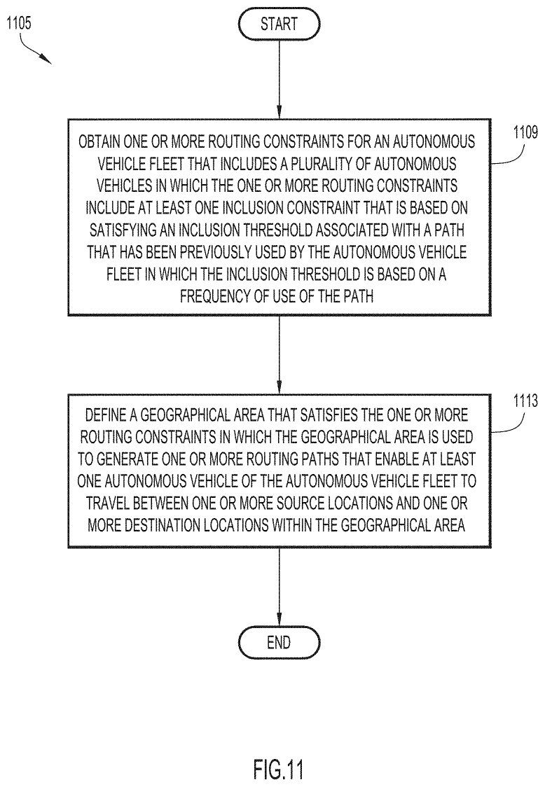

FIG. 11 a process flow diagram which illustrates another method 1105, in accordance with an embodiment. In at least one embodiment, method 1105 may be performed by a dynamic routing system, such as dynamic routing system 720.

In at least one embodiment, method 1105 may begin at 1109 in which one or more routing constraints are obtained for an autonomous vehicle fleet that includes a plurality of autonomous vehicles in which the one or more routing constraints include at least one inclusion constraint that is based on satisfying an inclusion threshold associated with a path that has been previously used by the autonomous vehicle fleet in which the inclusion threshold is based on a frequency of use of the path.

The inclusion threshold can be a value indicating the frequency of use of the path by one or more autonomous vehicles of the autonomous vehicle fleet within a predetermined period of time. In at least one embodiment, satisfying the inclusion threshold indicates that the one or more points of interest are not suitable for inclusion in the geographical area or are not suitable for inclusion in the one or more routing paths that enable the at least one autonomous vehicle to travel between one or more source locations and one or more destination locations within the geographical area.

At 1113, the method may include defining a geographical area that satisfies the one or more routing constraints in which the geographical area is used to generate one or more routing paths that enable the at least one autonomous vehicle of the autonomous vehicle fleet to travel between one or more source locations and one or more destination locations within the geographical area. In various embodiments, defining geographical area can include defining boundaries of the geographical area using any combination of coordinate system(s) (e.g., X-Y, GPS, latitude/longitude), mapping indicators, positional indicators, locations, roads, lane(s) of road(s), intersections/cross roads, combinations thereof, and/or the like and/or, in some instances, denoting or otherwise identifying one or more point(s) of interest or location(s), if included in the geographical area, as not suitable for inclusion in one or more routing paths generated for the geographical area.

Although only a few embodiments have been described in this disclosure, it should be understood that the disclosure may be embodied in many other specific forms without departing from the spirit or the scope of the present disclosure. By way of example, constraints applied when defining a geographical area within which paths between one or more source locations and one or more destination locations may be routed may vary widely. Lane restrictions, speed limits, and restrictions involving unprotected turns have been described as constraints which may be applied. Other constraints which may be applied include, but are not limited to including, limits on distances to travel and/or a number of turns allowed.

In still some instances, a point of interest such as a building, as well as a point of interest such as at least one lane of a particular road, have been described as having associated thresholds for a frequency with which the point of interest may be included in or along a routing path. In one embodiment, a point of interest may be a geographic zone which includes more than a single building or a lane of a particular road. For instance, a point of interest may be a particular neighborhood within a geographical area, certain streets of a neighborhood, school zones, combinations thereof, and/or the like.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

In one form, a computer-implemented method is provided that may include obtaining one or more routing constraints for an autonomous vehicle fleet comprising a plurality of autonomous vehicles, wherein the one or more routing constraints comprise at least one inclusion constraint that is based on satisfying an inclusion threshold associated with a path that has been previously used by the autonomous vehicle fleet in which the inclusion threshold is based on a frequency of use of the path; and defining a geographical area that satisfies the one or more routing constraints, wherein the geographical area is used to generate one or more routing paths that enable at least one autonomous vehicle of the autonomous vehicle fleet to travel between one or more source locations and one or more destination locations within the geographical area. In one instance, the inclusion threshold is a value indicating the frequency of use of the path by one or more autonomous vehicles of the autonomous vehicle fleet within a predetermined period of time.

In one instance, the computer-implemented method may include determining that at least one inclusion threshold that was previously satisfied is no longer satisfied; and removing the at least one inclusion constraint from the one or more routing constraints. In one instance, the computer-implemented method may further include updating the geographical area to trigger updating at least one routing path of the one or more routing paths that enable the at least one autonomous vehicle to travel between one or more source locations and one or more destination locations. In one instance, the determining includes determining a reset condition is satisfied. In one instance, reset condition is associated with the predetermined period of time being satisfied, expiring, or being reset.

In one instance, the path is associated with one or more points of interest within the geographical area. In one instance, the one or more points of interest include at least one of: two or more lanes of at least one road in which the two or more lanes of the at least one road are associated with two different directions of travel; one lane of at least one road associated with one direction of travel; or one or more geographical addresses or positions located along one or more lanes of at least one road.

In one instance, satisfying the inclusion threshold indicates that the one or more points of interest are not suitable for inclusion in the geographical area or are not suitable for inclusion in the one or more routing paths that enable the at least one autonomous vehicle to travel between the one or more source locations and the one or more destination locations. In one instance, the one or more routing constraints further comprise one or more of: one or more speed constraints; one or more road hazard or road closure constraints; one or more operational constraints associated with the autonomous vehicle fleet, one or more roads, or one or more lanes of one or more roads; or one or more communication constraints associated with wireless communication signal strength for communications involving the autonomous vehicle fleet.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media encoded with instructions and transitory propagating signals.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising or otherwise encoded with instructions that can be understood and processed on a server, computer, processor, machine, compute node, combinations thereof, or the like and may further include library modules loaded during execution, object files, system files, hardware logic, software logic, or any other executable modules.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein but may be modified within the scope of the appended claims.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining one or more routing constraints for an autonomous vehicle fleet comprising a plurality of autonomous vehicles, wherein the one or more routing constraints comprise at least one inclusion constraint that is based on satisfying an inclusion threshold associated with a path that has been previously used by the autonomous vehicle fleet in which the inclusion threshold is based on a frequency of use of the path; and
defining a geographical area that satisfies the one or more routing constraints, wherein the geographical area is used to generate one or more routing paths that enable at least one autonomous vehicle of the autonomous vehicle fleet to travel between one or more source locations and one or more destination locations within the geographical area.

2. The computer-implemented method of claim 1, wherein the inclusion threshold is a value indicating the frequency of use of the path by one or more autonomous vehicles of the autonomous vehicle fleet within a predetermined period of time.

3. The computer-implemented method of claim 2, further comprising:
determining that at least one inclusion threshold that was previously satisfied is no longer satisfied; and
removing the at least one inclusion constraint from the one or more routing constraints.

4. The computer-implemented method of claim 3, further comprising:
updating the geographical area to trigger updating at least one routing path of the one or more routing paths that enable the at least one autonomous vehicle to travel between one or more source locations and one or more destination locations.

5. The computer-implemented method of claim 4, wherein the determining includes determining a reset condition is satisfied.

6. The computer-implemented method of claim 5, wherein the reset condition is associated with the predetermined period of time being satisfied, expiring, or being reset.

7. The computer-implemented method of claim 2, wherein the path is associated with one or more points of interest within the geographical area.

8. The computer-implemented method of claim 7, wherein the one or more points of interest include at least one of:
two or more lanes of at least one road in which the two or more lanes of the at least one road are associated with two different directions of travel;
one lane of at least one road associated with one direction of travel; or
one or more geographical addresses or positions located along one or more lanes of at least one road.

9. The computer-implemented method of claim 7, wherein satisfying the inclusion threshold indicates that the one or more points of interest are not suitable for inclusion in the geographical area or are not suitable for inclusion in the one or more routing paths that enable the at least one autonomous vehicle to travel between the one or more source locations and the one or more destination locations.

10. The computer-implemented method of claim 1, wherein the one or more routing constraints further comprise one or more of:
one or more speed constraints;
one or more road hazard or road closure constraints;
one or more operational constraints associated with the autonomous vehicle fleet, one or more roads, or one or more lanes of one or more roads; or
one or more communication constraints associated with wireless communication signal strength for communications involving the autonomous vehicle fleet.

11. One or more non-transitory computer readable storage media encoded with instructions that, when executed by a processor, cause the processor to perform operations, comprising:
obtaining one or more routing constraints for an autonomous vehicle fleet comprising a plurality of autonomous vehicles, wherein the one or more routing constraints comprise at least one inclusion constraint that is based on satisfying an inclusion threshold associated with a path that has been previously used by the autonomous vehicle fleet in which the inclusion threshold is based on a frequency of use of the path; and
defining a geographical area that satisfies the one or more routing constraints, wherein the geographical area is used to generate one or more routing paths that enable at least one autonomous vehicle of the autonomous vehicle fleet to travel between one or more source locations and one or more destination locations within the geographical area.

12. The media of claim 11, wherein the inclusion threshold is a value indicating the frequency of use of the path by one or more autonomous vehicles of the autonomous vehicle fleet within a predetermined period of time.

13. The media of claim 12, wherein the path is associated with one or more points of interest within the geographical area.

14. The media of claim 13, wherein the one or more points of interest include at least one of:
two or more lanes of at least one road in which the two or more lanes of the at least one road are associated with two different directions of travel;
one lane of at least one road associated with one direction of travel; or
one or more geographical addresses or positions located along one or more lanes of at least one road.

15. The media of claim 13, wherein satisfying the inclusion threshold indicates that the one or more points of interest are not suitable for inclusion in the geographical area or are not suitable for inclusion in the one or more routing paths that enable the at least one autonomous vehicle to travel between the one or more source locations and the one or more destination locations.

16. An apparatus comprising:
at least one memory element for storing data; and
at least one processor for executing instructions associated with the data, wherein executing the instructions causes the apparatus to perform operations, comprising:
obtaining one or more routing constraints for an autonomous vehicle fleet comprising a plurality of autonomous vehicles, wherein the one or more routing constraints comprise at least one inclusion constraint that is based on satisfying an inclusion threshold associated with a path that has been previously used by the autonomous vehicle fleet in which the inclusion threshold is based on a frequency of use of the path; and
defining a geographical area that satisfies the one or more routing constraints, wherein the geographical area is used to generate one or more routing paths that enable at least one autonomous vehicle of the autonomous vehicle fleet to travel between one or more source locations and one or more destination locations within the geographical area.

17. The apparatus of claim 16, wherein the inclusion threshold is a value indicating the frequency of use of the path by one or more autonomous vehicles of the autonomous vehicle fleet within a predetermined period of time.

18. The apparatus of claim 17, wherein the path is associated with one or more points of interest within the geographical area.

19. The apparatus of claim 18, wherein the one or more points of interest include at least one of:
two or more lanes of at least one road in which the two or more lanes of the at least one road are associated with two different directions of travel;
one lane of at least one road associated with one direction of travel; or
one or more geographical addresses or positions located along one or more lanes of at least one road.

20. The apparatus of claim 18, wherein satisfying the inclusion threshold indicates that the one or more points of interest are not suitable for inclusion in the geographical area or are not suitable for inclusion in the one or more routing paths that enable the at least one autonomous vehicle to travel between the one or more source locations and the one or more destination locations.
